(19) United States
(12) Patent Application Publication
(10) Pub. No.: US 2011/0183152 A1
(43) Pub. Date: Jul. 28, 2011

(54) BRACE BAR WITH TABBED APERTURES FOR BRAZING TO A FLOW TUBE

(76) Inventors: Gregory Treat Lanham, Longmont, CO (US); Christopher A. Werbach, Longmont, CO (US); Richard L. Woolf, Berthoud, CO (US)

(21) Appl. No.: 12/672,726

(22) PCT Filed: Aug. 29, 2007
(86) PCT No.: PCT/US07/77090

§ 371 Date: Feb. 9, 2010

(51) Int. Cl. B32B 1/08; B23P 11/00; B32B 3/10; B32B 15/01

(52) U.S. Cl. 428/597; 29/428; 137/15.01

(57) ABSTRACT

A brace bar (200) is provided. The brace bar (200) includes a brace bar plate (206). At least one aperture (201) is formed in the brace bar plate (206). The brace bar (200) also includes at least one tab (202) located proximate the at least one aperture (201) and extending from the brace bar plate (206). The brace bar (200) can be brazed to a flow tube (205). The at least one tab (202) allows the brazing coupling material to wick into the joint (210) created between the at least one tab (202) and the flow tube (205).

### TECHNICAL FIELD

The present invention relates to brace bars, and more particularly, to a brace bar with a reduced coupling gap.

### BACKGROUND OF THE INVENTION

Brazing is a widely accepted method for bonding two structural elements together. Typically brazing involves applying a brazing material to the surfaces of one or both of the elements that are to be joined together. The elements then undergo a high temperature brazing process that melts the brazing material. If the elements are contacting one another, as the brazing material cools, the elements become substantially permanently coupled to one another.

Problems can exist within the brazing material if the gap between the elements is too large. A large gap between the elements results in the need for a greater quantity of brazing material. As the quantity of brazing material increases, the chance of imperfect brazing also increases. Examples of imperfect brazing include voids in the brazing material, uneven contours and cracks, and inadequate brazing material to sufficiently fill the gap between the elements to be brazed. Because of these problems, it is often desirable to minimize the gap between the elements.

Flow meters, and in particular, Coriolis flow meters have benefited from brazing. Many Coriolis flow meters include one or more brace bars towards the end of the flow tube/tubes prior to a flange. Each brace bar has a center opening for receiving a flow tube which projects through the brace bars. The brace bars are typically brazed to the flow tube/tubes on their inner circumference. The brace bar provides a path that permits the brace bar and flow tube to be connected into a single vibrating structure. However, in order for the brace bar to be effective, it is critical that the brazing between the flow tube and the brace bar is not flawed.

A problem in the past has been the ability to provide a large enough center opening for receiving the flow tube without damaging it, but maintaining a minimum gap so the brazing material will fill in, while at the same time preventing the formation of voids. Once a void in the brazing material is discovered, the brace bar is typically discarded resulting in increased costs for the manufacturer. Similar problems occur with other coupling processes. The present invention overcomes this and other problems and an advance in the art is achieved.

### SUMMARY OF THE INVENTION

A brace bar is provided according to an embodiment of the invention. The brace bar comprises a brace bar plate and at least one aperture formed in the brace bar plate. The brace bar further comprises at least one tab located proximate the at least one aperture and extending from the brace bar plate.

A flow tube assembly including at least one flow tube and a brace bar is provided according to an embodiment of the invention. The brace bar comprises a brace bar plate and at least one aperture formed in the brace bar plate. The brace bar further comprises at least one tab located proximate the at least one aperture and extending from the brace bar plate. The at least one flow tube is positioned within the at least one aperture.

A method for forming a brace bar including a brace bar plate and at least one tab is provided according to an embodiment of the invention. The method comprises the steps of forming at least one aperture in the brace bar plate and locating the at least one tab proximate the at least one aperture and extending the at least one tab from the brace bar plate.

A method for forming a flow tube assembly including a brace bar and at least one flow tube is provided according to an embodiment of the invention. The method comprises the steps of forming at least one aperture in a brace bar plate and locating at least one tab proximate the at least one aperture and extending the at least one tab from the brace bar plate. The method further comprises the step of positioning the at least one flow tube within the at least one aperture.

### Aspects

In one embodiment of the apparatus, the at least one tab is at least partially deformable.

In another embodiment of the apparatus, the at least one tab extends from an interior of the at least one aperture.

In yet another embodiment of the apparatus, the at least one tab comprises a plurality of tabs located at least partially around a perimeter of the at least one aperture.

In yet another embodiment of the apparatus, the at least one tab substantially conforms to an outer circumference of the at least one flow tube.

In yet another embodiment of the apparatus, the at least one tab contacts an outer circumference of the at least one flow tube.

In yet another embodiment of the apparatus, the at least one tab is coupled to the at least one flow tube.

In yet another embodiment of the apparatus, the at least one tab is coupled to the flow tube and the at least one tab can at least partially flex after the at least one tab is coupled to the at least one flow tube.

In one embodiment of the method, the method further comprises the step of extending the at least one tab from an interior of the at least one aperture.

In another embodiment of the method, the at least one tab comprises a plurality of tabs and the method further includes the step of locating a plurality of tabs at least partially around a perimeter of the at least one aperture.

In yet another embodiment of the method, the method further comprises the step of substantially conforming the at least one tab to an outer circumference of the at least one flow tube.

In yet another embodiment of the method, the method further comprises the step of contacting the at least one flow tube with the at least one tab.

In yet another embodiment of the method, the method further comprises the step of coupling the at least one tab to the at least one flow tube.

In yet another embodiment of the method, the method further comprises the step of coupling the at least one tab to the at least one flow tube wherein the at least one tab can at least partially flex after the at least one tab is coupled to the at least one flow tube.

### BRIEF DESCRIPTION OF THE DRAWINGS

FIG. 1 shows a prior art brace bar.

FIG. 2 shows a reduced coupling gap brace bar according to an embodiment of the invention.

FIG. 3a shows a cross-sectional view of the tabs of the brace bar according to an embodiment of the invention.

FIG. 3b shows a cross-sectional view of the tabs of the brace bar according to another embodiment of the invention.

FIG. 3c shows a cross-sectional view of the tabs of the brace bar according to another embodiment of the invention.

FIG. 3d shows a cross-sectional view of the tabs of the brace bar according to another embodiment of the invention.

### DETAILED DESCRIPTION OF THE INVENTION

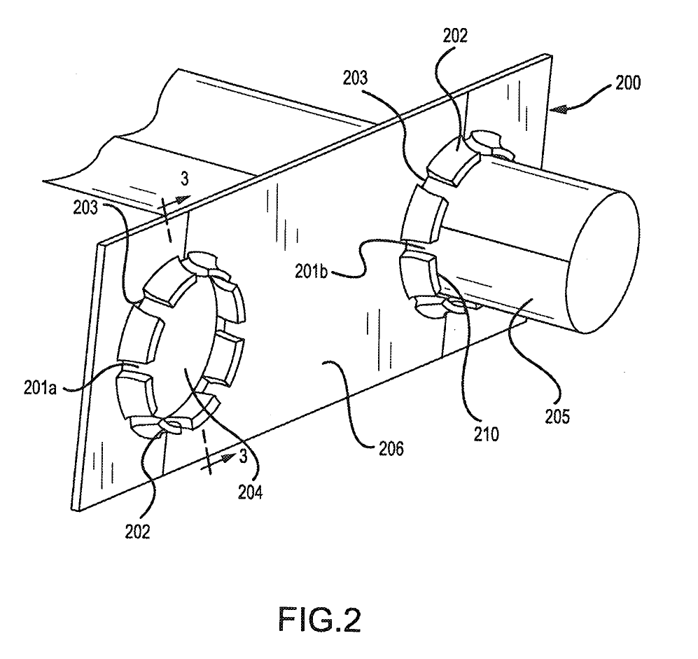

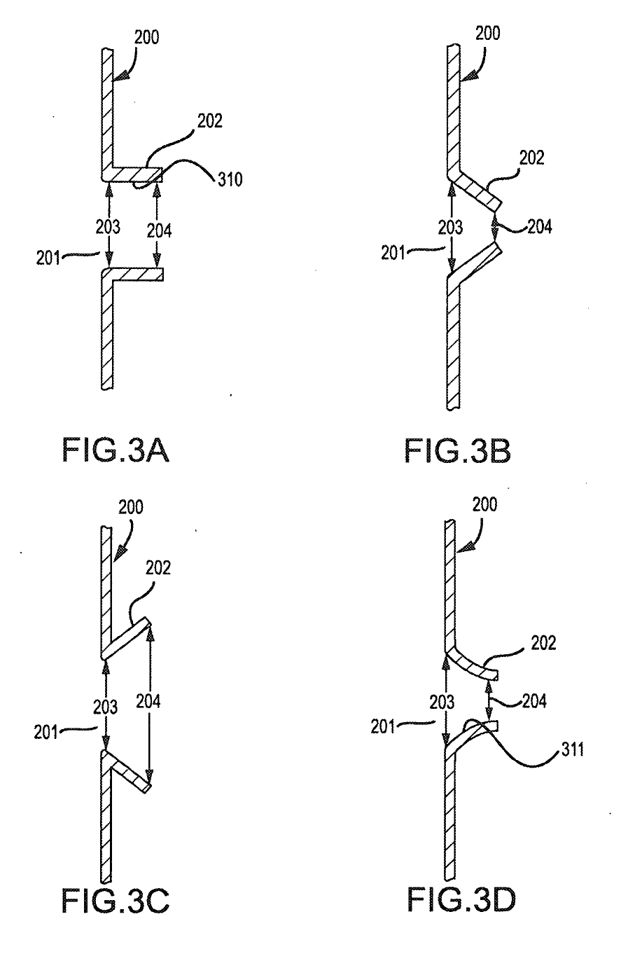

FIG. 2-3 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

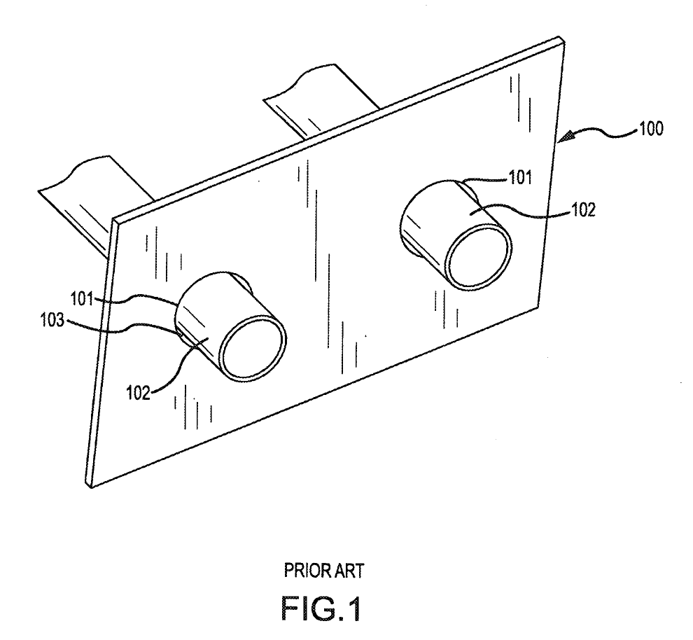

FIG. 1 shows a prior art brace bar 100 for a flow tube. The brace bar 100 includes a plurality of flow tube apertures 101, which are sized and located to accept flow tubes 102. As can be seen, the flow tube apertures 101 are slightly larger than the outer circumference of the flow tubes 102. This enlargement is necessary so the flow tubes can be inserted and so the flow tubes 102 are not damaged while being inserted into the brace bar 100. As a result, a gap 103 exists between the flow tube apertures 101 and the outer circumference of the flow tubes 102. The gap 103 can be problematic when a manufacturer attempts to couple the brace bar 100 to the flow tubes 102. The gap 103 can cause voids in the coupling material or can cause uneven stress points which can result in a premature failure of the brace bar 100. Additionally, a large amount of coupling material must be used to fill the gap 103, thus resulting in increased costs associated with the brace bar 100. Typically, the coupling material has less strength than the flow tubes 102. Thus, the greater amount of coupling material necessary, the weaker the coupling.

FIG. 2 shows a brace bar 200 according to an embodiment of the invention. The brace bar 200 comprises a brace bar plate 206. Although the plate 206 is shown as a single and uniform component, it should be understood that in some embodiments, the plate 206 comprises two or more portions joined together. The particular method of joining the two or more portions together is not important for the present invention and should not limit the scope of the invention. Typically, the method of joining the two or more portions together will depend on the particular material used for the brace bar 200. Additionally, although the brace bar plate 206 is shown as rectangular in shape and having a substantially uniform surface, the invention is not limited to this embodiment. Other shape brace bar plates may be used and the particular shape is not limited to rectangular. Similarly, the brace bar plate 206 may include a non-uniform surface.

The brace bar 200 includes at least one aperture 201 formed in the brace bar plate 206. In the embodiment shown in FIG. 2, the brace bar plate 206 includes two apertures 201a&b. According to one embodiment of the invention, the apertures 201 comprise flow tube apertures. However, the invention should not be limited to flow tube apertures as the apertures 201 may be provided for a variety of applications. While two apertures 201a&b are shown in FIG. 2, it should be understood that the number of apertures can vary depending on the particular application and thus, the number of apertures should not limit the scope of the invention. Furthermore, the apertures 201 are shown as being substantially circular. It should be understood however, that the shape of the apertures 201 can vary depending on the application.

As shown in FIG. 2, a flow tube 205 is inserted into the aperture 201b. When the brace bar 200 is combined with a flow tube 205, the combined assembly may, in some embodiments, form part of a larger flow tube assembly. While a flow tube 205 is shown only inserted into the aperture 201b, it should be understood that this is done solely for the purpose of clarity and a flow tube 205 can be inserted into both of the apertures 201a&b. Furthermore, while the discussion below refers to flow tubes, it should be understood that the apertures 201 are described in combination with flow tubes solely for the purpose of consistency and other devices may be inserted through the apertures 201.

The apertures 201 define a first opening 203. According to an embodiment of the invention, the first opening 203 is larger than the outer circumference of the flow tube 205. While the apertures 201 can define a first opening 203 that is substantially the same size as the flow tube 205, there is a risk that the flow tube 205 could be damaged upon insertion. Furthermore, if the first opening 203 is substantially the same size as the outer circumference of the flow tube 205, the operating temperature range is severely limited. This is because the brace bar 200 and the flow tube 205 may be formed from different materials having different temperature expansion coefficients. Thus, if the flow tube 205 expands at a different rate than the brace bar 200, the flow tube 205 could be damaged upon an increase or a decrease in temperature.

The brace bar 200 also includes at least one tab 202. The at least one tab 202 is positioned proximate the at least one aperture and extends from the brace bar plate 206. In the embodiment shown in FIG. 2, a plurality of tabs 202 are provided, however, it should be understood that some embodiments only include a single tab 202. Although the embodiment shown in FIG. 2 shows the tabs 202 extending from an interior of the apertures 201, in other embodiments, the tabs 202 can extend from other portions of the brace bar plate 206.

According to the embodiment shown in FIG. 2, the tabs 202 are substantially evenly spaced around the perimeter of the apertures 201. However, in other embodiments, the spacing can vary and may not be substantially uniform. The tabs 202 can be machined, punched, or cut out during manufacture of the brace bar 200, therefore, minimizing the number of parts needed. However, the tabs 202 do not need to be machined or cut out and may be provided using other known methods, such as adhesives, welding, etc. Furthermore, although each tab 202 is shown as being formed from a single piece of material, however, it should be understood that the tabs 202 may be formed from more than one piece.

According to an embodiment of the invention, the at least one tab 202 defines at least a second opening 204. The tabs 202 can be configured to accept a device. In some embodiments, the tabs 202 can be configured to accept a tube, such as flow tube 205. FIGS. 3A-D show a cross sectional view of FIG. 2 taken along the line 3-3. The figures show a number of tab arrangements according to different embodiments of the invention.

FIG. 3A shows the tabs 202 extending in a substantially perpendicular direction with respect to the apertures 201. In this embodiment, the second opening 204 is substantially the same size as the first opening 203. Although the openings 203, 204 are substantially the same size, the tabs 202 provide an increased surface area 310 for coupling. It should be understood that the term coupling can include any manner of bonding, brazing, gluing, laser welding, or other known methods of attaching two elements together. The particular method of coupling will typically depend on the material used for either or both the flow tube 205 and the brace bar 200.

FIG. 3B shows the tabs 202 extending in a direction less than perpendicular with respect to the apertures 201. In this embodiment, the second opening 204 defined by the tabs 202 is smaller than the first opening 203 defined by the apertures 201. According to an embodiment of the invention, the second opening 204 is also smaller than the outer circumference of the flow tube 205. In this embodiment, the insertion of the flow tube 205 may partially deform the tabs 202.

FIG. 3C shows the tabs 202 extending in a direction greater than perpendicular with respect to the apertures 201. In this embodiment, the second opening 204 is larger than the first opening 203. In embodiments in which the tabs 202 extend in a direction greater than perpendicular with respect to the apertures 201, the tabs 202 may be pressed or squeezed inwards after a flow tube 205 is inserted through the aperture 201. The tabs 202 may be pressed or squeezed inwards until they contact the outer circumference of the flow tube 205.

FIG. 3D shows the tabs 202 being formed slightly curved. In some applications, it may be desirable to provide the tabs 202 with curves 311 to reduce the risk of damaging the flow tubes 205. The curve 311 in the tabs 202 create a smooth surface for the flow tube 205 to slide along as it is being inserted through the first 203 and second 204 openings. Although FIG. 3D shows the tabs 202 being formed with a curve 311 when they extend in a direction less than perpendicular with respect to the apertures 201, it should be understood that the tabs 202 can include the curve 311 regardless of the direction in which they extend.

Referring again to FIG. 2, although the tabs 202 can create a second opening 204 that is smaller than the outer circumference of the flow tube 205, i.e., when the tabs 202 extend in a direction less than perpendicular with respect to the aperture 201, the flow tube 205 is not damaged upon insertion as would be the case if the aperture 101 were smaller than the flow tubes 102. This is because the tabs 202 are preferably flexible enough to partially deform as a flow tube 205 is inserted into the aperture 201. Therefore, although the tabs 202 define an opening smaller than the outer circumference of the flow tube 205, the tabs 202 may still accept the flow tube 205 without causing damage. Furthermore, changes in temperature will not damage the flow tube 205 as the tabs 202 can at least partially flex in response to different rates of change between the brace bar 200 and the flow tube 205. The tabs 202 can still flex after the tabs 202 are coupled to the outer circumference of the flow tube 205.

As the flow tube 205 is inserted into the aperture 201, the tabs 202 flex and partially deform in order to maintain contact with the outer circumference of the flow tube 205. In this manner, the tabs 202 substantially conform to the outer circumference of the flow tube 205. Or in embodiments, such as shown in FIG. 3C, the tabs 202 can be squeezed inwards until they contact the flow tube 205. Once the flow tube 205 is in the desired position, the tabs 202 can be coupled to the flow tube 205. Unlike prior art brace bars, where a gap such as gap 103 exists, the brace bar 200 does not create such a gap. This is because the tabs 202 maintain a tight fit with the flow tube 205. The tabs 202 allow the coupling material to wick into the joint 210 created between the tabs 202 and the flow tube 205. This produces a better and more consistent joint than could be realized in the prior art. Furthermore, the brace bar 200 allows the coupling to occur with less coupling material, thus reducing the cost as well. Furthermore, the tabs 202 allow the flow tube 205 and brace bar 200 to withstand greater temperature variances as the tabs 202 can at least partially flex in response to changes due to temperature even after the tabs 202 are coupled to the flow tube 205.

The detailed descriptions of the above embodiments are not exhaustive descriptions of all embodiments contemplated by the inventors to be within the scope of the invention. Indeed, persons skilled in the art will recognize that certain elements of the above-described embodiments may variously be combined or eliminated to create further embodiments, and such further embodiments fall within the scope and teachings of the invention. It will also be apparent to those of ordinary skill in the art that the above-described embodiments may be combined in whole or in part to create additional embodiments within the scope and teachings of the invention.

Thus, although specific embodiments of, and examples for, the invention are described herein for illustrative purposes, various equivalent modifications are possible within the scope of the invention, as those skilled in the relevant art will recognize. The teachings provided herein can be applied to other brace bars, and not just to the embodiments described above and shown in the accompanying figures. Accordingly, the scope of the invention should be determined from the following claims.

We claim:

1. A brace bar (200), comprising:
a brace bar plate (206);
at least one aperture (201) formed in the brace bar plate (206); and
at least one tab (202) located proximate the at least one aperture (201) and extending from the brace bar plate (206).

2. The brace bar (200) of claim 1, wherein the at least one tab (202) is at least partially deformable.

3. The brace bar (200) of claim 1, wherein the at least one tab (202) extends from an interior of the at least one aperture (201).

4. The brace bar (200) of claim 1, wherein the at least one tab (202) comprises a plurality of tabs (202) located at least partially around a perimeter of the at least one aperture (201).

5. A flow tube assembly, including:
at least one flow tube and a brace bar (200), wherein the brace bar (200) comprises:
a brace bar plate (206);
at least one aperture (201) formed in the brace bar plate (206);
at least one tab (202) located proximate the at least one aperture and extending from the brace bar plate (206); and
wherein the at least one flow tube (205) is positioned within the at least one aperture (201).

6. The flow tube assembly of claim 5, wherein the at least one tab (202) extends from an interior of the at least one aperture (201).

7. The flow tube assembly of claim 5, wherein the at least one tab (202) comprises a plurality of tabs (202) located at least partially around a perimeter of the at least one aperture (201).

8. The flow tube assembly of claim 5, wherein the at least one tab (202) is at least partially deformable.

9. The flow tube assembly of claim 5, wherein the at least one tab (202) substantially conforms to an outer circumference of the at least one flow tube (205).

10. The flow tube assembly of claim 5, wherein the at least one tab (202) contacts an outer circumference of the at least one flow tube (205).

11. The flow tube assembly of claim 10, wherein the at least one tab (202) is coupled to the at least one flow tube (205).

12. The flow tube assembly of claim 10, wherein the at least one tab (202) is coupled to the at least one flow tube (205) and wherein the at least one tab (202) can at least partially flex after the at least one tab is coupled to the at least one flow tube (205).

13. A method for forming a brace bar including a brace bar plate and at least one tab, the method comprises the following steps:
forming at least one aperture in the brace bar plate; and
locating the at least one tab proximate the at least one aperture and extending from the brace bar plate.

14. The method of claim 13, further comprising the step of:
extending the at least one tab from an interior of the at least one aperture.

15. The method of claim 13, further comprising the step of:
locating a plurality of tabs at least partially around a perimeter of the at least one aperture.

16. A method for forming a flow tube assembly including a brace bar and at least one flow tube, wherein forming the flow tube assembly comprises the steps of:
forming at least one aperture in a brace bar plate;
locating at least one tab proximate the at least one aperture and extending from the brace bar plate; and
positioning the at least one flow tube within the at least one aperture.

17. The method of claim 16, further comprising the step of:
extending the at least one tab from an interior of the at least one aperture.

18. The method of claim 16, wherein the at least one tab comprises a plurality of tabs and the method further includes the step of:
locating the plurality of tabs at least partially around a perimeter of the at least one aperture.

19. The method of claim 16, further comprising the step of:
substantially conforming the at least one tab to an outer circumference of the at least one the flow tube.

20. The method of claim 16, further comprising the step of:
contacting an outer circumference of the at least one flow tube with the at least one tab.

21. The method of claim 20, further comprising the step of:
coupling the at least one tab to the at least one flow tube.

22. The method of claim 20, further comprising the step of:
coupling the at least one tab to the at least one flow tube such that the at least one tab can at least partially flex after the at least one tab is coupled to the at least one flow tube.
